(19) United States
(12) Patent Application Publication
(10) Pub. No.: US 2014/0156163 A1
(43) Pub. Date: Jun. 5, 2014

(54) AUTO CRUISE DOWNHILL CONTROL METHOD FOR VEHICLE

(71) Applicants: HYUNDAI MOTOR COMPANY, Seoul (KR); KIA MOTORS CORPORATION, Seoul (KR); MANDO CORPORATION, Pyeongtaek (KR)

(72) Inventors: Ju Hoon Shin, Suwon (KR); Kwang Jin Park, Hwaseong (KR); Soon Young Jung, Hwaseong (KR)

(73) Assignees: HYUNDAI MOTOR COMPANY, Seoul (KR); MANDO CORPORATION, Pyeongtaek (KR); KIA MOTORS CORPORATION, Seoul (KR)

(21) Appl. No.: 13/855,179

(22) Filed: Apr. 2, 2013

(30) Foreign Application Priority Data
Dec. 3, 2012 (KR) 10-2012-0139088

(51) Int. Cl. B60K 31/00

(52) U.S. Cl. CPC B60K 31/00; B60K 2310/00
USPC 701/94

(57) ABSTRACT

Disclosed herein is an auto cruise downhill control (ADC) method for a vehicle, whereby, when a speed of the vehicle exceeds an auto cruise setting speed, the speed of the vehicle is automatically adjusted to be the auto cruise setting speed by using an engine control unit (ECU) and an electronic stability control (ESC) unit. In other words, when a current vehicle speed exceeds a predetermined value compared to a driver's setting speed for auto cruise, automatic braking activation control is performed by the ESC unit to adjust the speed of the vehicle to be the auto cruise setting speed when the vehicle is operating on a steep decline. Additionally, when a driver makes a steep downward adjustment of the setting speed, automatic braking activation control is performed by the ESC unit to decrease the speed of the vehicle to a downwardly adjusted level at an accelerated rate.

### CROSS-REFERENCE TO RELATED PATENT APPLICATION

This application claims the benefit of Korean Patent Application No. 10-2012-0139088, filed on Dec. 3, 2012 in the Korean Intellectual Property Office, the disclosure of which is incorporated herein in its entirety by reference.

### BACKGROUND OF THE INVENTION

1. Field of the Invention

The present invention relates to an auto cruise downhill control (ADC) method for a vehicle, and more particularly, to an ADC method for a vehicle, whereby, when the speed of the vehicle deviates from an auto cruise setting speed, the speed of the vehicle may be automatically adjusted to be the auto cruise setting speed by using an engine control unit (ECU) and an electronic stability control (ESC) unit.

2. Description of the Related Art

Auto cruise control systems that are constant speed driving apparatuses or automatic speed adjusting apparatuses, allow the speed of a vehicle to be maintained at a constant driving speed by simple activation switch manipulation to increase driving convenience by reducing an accelerator pedal operating force.

By using auto cruise control, the quantity of injected fuel of an engine is adjusted based on information regarding the speed of the vehicle measured by a wheel sensor. Thus, a vehicle may be driven according to a speed limit and an economical speed without viewing the speedometer of a cluster.

When a vehicle drives uphill, the speed of the vehicle decreases unless an accelerator pedal is engaged. Thus, the quantity of fuel to be supplied to an engine increases by auto cruise control to maintain the speed of the vehicle at a constant speed without being decreased. Alternatively, when the vehicle drives downhill, the speed of the vehicle increases. Thus, the quantity of fuel to be supplied to the engine decreases by auto cruise control to maintain the speed of the vehicle at a constant speed without being increased.

A series of auto cruise control technologies are performed by an engine control unit (ECU) (e.g., a microprocessor) that receives signals from various sensors. Since vehicles drive at constant speeds, fuel consumption by sudden acceleration can be prevented, and thus, mileage improvements can be achieved.

However, when vehicles drive on steep downhill ramps, the speed of the vehicle is suddenly increased. Thus, there is a substantial difference between the speed of the vehicle and a speed set by a driver for auto cruise. As a result, an auto cruise control operation may be stopped.

Additionally, when the driver makes a steep downward adjustment of the setting speed for auto cruise, the speed of the vehicle should be decreased to a downwardly adjusted level at an accelerated rate; however, the speed of the vehicle is instead slowly decreased to the downwardly adjusted level.

### SUMMARY

The present invention provides an auto cruise downhill control (ADC) method for a vehicle, including: performing automatic braking activation control using an electronic stability control (ESC) unit when the speed of the vehicle exceeds a predetermined value compared to a speed set by a driver for auto cruise, to maintain vehicle speed at the set speed when the vehicle is operating on a steep decline.

The present invention also provides an ADC method for a vehicle, including: performing automatic braking activation control using an ESC unit when a driver makes a steep downward adjustment of a setting speed for auto cruise, to decrease the speed of the vehicle up to a downwardly adjusted level at an accelerated rate.

One aspect of the present invention, provides an auto cruise downhill control (ADC) method for a vehicle, the method including: transmitting a target deceleration value to an electronic stability control (ESC) unit from an engine control unit (ECU) when a braking force is required while the vehicle drives at an auto cruise setting speed; and performing ADC for automatic braking of the vehicle by using the ESC unit to brake the vehicle and automatically adjust a speed of the vehicle to the auto cruise setting speed.

ADC may include: calculating current deceleration based on a sensing value of a speed sensor disposed on a wheel, by using the ESC unit that receives target deceleration of the ECU; distributing hydraulic pressures for achieving target deceleration among one or more hydraulic brakes by using the ESC unit; and performing braking activation up to target deceleration by using the hydraulic brakes to adjust the speed of the vehicle to the auto cruise setting speed.

Furthermore, when the braking force is generated to achieve target deceleration, the engine control unit (ECU) may calculate appropriate deceleration consecutively and may transmit the calculated appropriate deceleration to the ESC unit to variably adjust a hydraulic braking force adjusted by the ESC unit.

ADC may be automatically performed when the vehicle is operating on a steep decline and the current vehicle speed exceeds a predetermined value compared to a driver's auto cruise setting speed and when a driver makes a steep downward adjustment of the auto cruise setting speed.

When a required deceleration signal of the ECU is transmitted to the ESC unit, the ESC unit may calculate a final target deceleration for ADC by using parameters including a required deceleration following cycle and a required deceleration following quantity of the ECU. Furthermore, when a pressure sensor of the ESC unit is operating, a brake lamp may be automatically turned on when a pressure detection value of the pressure sensor exceeds a predetermined reference value. In addition, when the pressure sensor of the ESC unit has failed, the brake lamp may be automatically turned on when a motor activation quantity of the ESC unit exceeds a reference value.

### BRIEF DESCRIPTION OF THE DRAWINGS

The above and other features and advantages of the present invention will become more apparent by describing in detail exemplary embodiments thereof with reference to the accompanying drawings in which:

FIG. 1 illustrates an exemplary configuration of an auto cruise downhill control (ADC) method for a vehicle according to an exemplary embodiment of the present invention;

FIGS. 2A and 2B are exemplary views comparing a vehicle driving status to which the ADC method according to the present invention is applied, and a vehicle driving status to which the ADC method according to the present invention is not applied;

FIG. 3 is an exemplary graph showing a change of the speed of a vehicle according to time when the ADC method according to the present invention is applied and when the ADC method according to the present invention is not applied, and a change of a wheel hydraulic braking pressure by control of an electronic stability control (ESC) unit according to an exemplary embodiment of the present invention;

FIG. 4 is an exemplary flowchart illustrating the ADC method illustrated in FIG. 1 according to an exemplary embodiment of the present invention; and

FIG. 5 is an exemplary waveform diagram illustrating a required signal of an engine control unit (ECU) processed as a target deceleration signal for smooth deceleration control, by using the ADC method of FIG. 1 according to an exemplary embodiment of the present invention.

### DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules/units and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will now be described more fully with reference to the accompanying drawings, in which exemplary embodiments of the invention are shown.

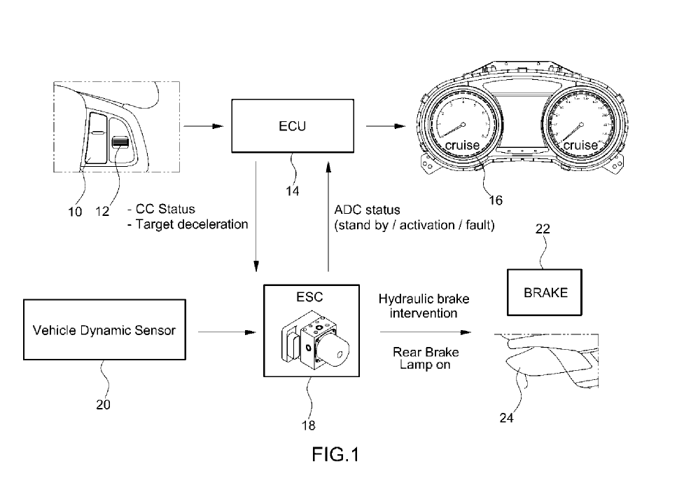

FIG. 1 illustrates an exemplary configuration of an auto cruise downhill control method for a vehicle according to an exemplary embodiment of the present invention.

In FIG. 1, reference numerals 10 and 12 represent an auto cruise on/off switch disposed on a steering wheel and a speed adjustment switch for adjusting a setting speed for auto cruise, respectively. Moreover, when the auto cruise on/off switch 10 is turned on and a desired driving speed is set using the speed adjustment switch 12, the quantity of fuel to inject may be controlled an engine control unit (ECU) 14 to allow a vehicle to drive at the setting driving speed.

Furthermore, a warning light indicating an auto cruise driving state, may be turned on at a cluster 16 disposed on a front side of a driver's seat.

In particular, according to the present invention, the ECU 14 and the electronic speed control (ESC) unit 18 may be connected to perform signal transmission, and a sensing value of a speed sensor 20 mounted on a wheel may be input to the ESC unit 18.

Furthermore, the ESC unit 18, is configured to stabilize the movement of the vehicle by generating a braking force using a hydraulic pressure to prevent the vehicle from being pulling toward in an opposite direction to a turning direction in which the vehicle is moving (in particular, while the vehicle is turning).

According to the present invention, when the vehicle drives at the auto cruise setting speed and requires braking force, the ECU 14 may transmit a target deceleration value to the ESC unit 18. Furthermore, when the ECU 14 transmits target deceleration of the vehicle to the ESC unit 18, the ESC unit 18 may be controlled to calculate current deceleration (e.g., deceleration that occurs by control to reduce the quantity of fuel applied by the ECU 14) based on the sensing value of the speed sensor 20 and then may distribute hydraulic pressure at which target deceleration may be achieved to the each of one or more hydraulic brakes 22 to allow the hydraulic brakes 22 to perform a braking operation.

Simultaneously, a rear brake lamp 24 may be turned on by the ESC unit, which will be described below in more detail.

Since the ESC unit 18 may distribute the hydraulic pressure suitable for target deceleration of the ECU 14 to the hydraulic brakes 22, the hydraulic brakes 22 may perform a braking operation up to target deceleration. As a result, the speed of the vehicle may be decreased by target deceleration required by the ECU 14.

In an exemplary embodiment of the present invention the ECU may include a first controller having a first processor and a first memory, wherein the first processor is configured to execute a process. Additionally, the ESC may include a second controller having a second processor and a second memory, wherein the second processor is configured to execute a process.

The ADC method for the vehicle having the configuration as described above will now be described below.

Auto cruise downhill control (ADC) according to an exemplary embodiment of the present invention is a control operation, in which, when the vehicle is operating on a steep decline, the ESC may automatically apply brakes when a current vehicle speed exceeds a predetermined value compared to a driver's setting speed for auto cruise to maintain the vehicle speed at the driver's setting speed. In addition, ADC is a control operation, in which, when a driver makes a steep downward adjustment of the setting speed for auto cruise, the ESC may enable the automatic braking operation to decrease the vehicle speed to a downwardly adjusted level at an accelerated rate.

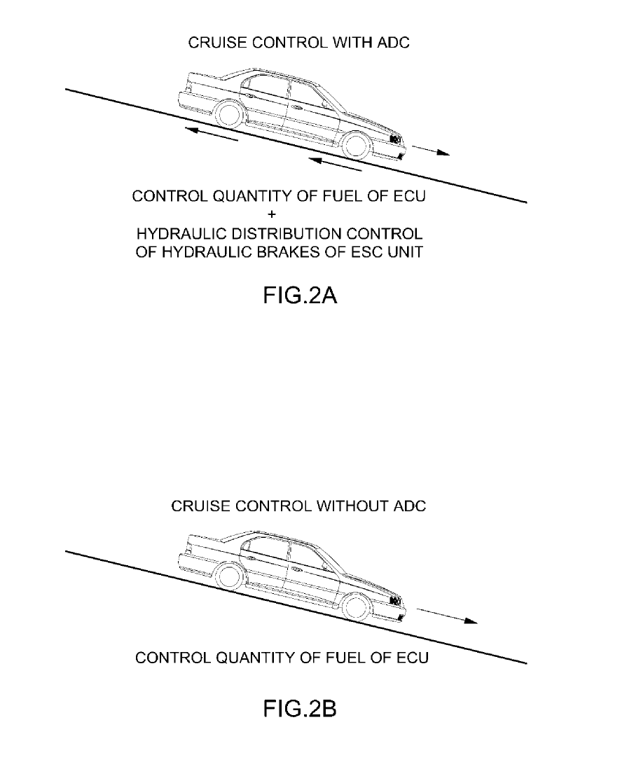

FIGS. 2A and 2B are exemplary views illustrating a comparison of a status (FIG. 2A) to which ADC is applied, and a status (FIG. 2B) to which ADC is not applied, when a vehicle drives a downhill.

Referring to FIG. 2B that illustrates cruise control without ADC, when the vehicle is operating on a decline in an auto cruise state and the speed of the vehicle is increased by inertia and downhill driving, the ECU may reduce the quantity of fuel to be supplied to an engine to maintain the auto cruise setting speed. However, when the speed of the vehicle is suddenly increased on the decline that the ECU may stop the auto cruise control.

Referring to FIG. 2A that illustrates cruise control with ADC, when the vehicle is operating on the decline in the auto cruise state and the speed of the vehicle is increased by inertia and downhill driving, the ECU may reduce the quantity of fuel to be supplied to an engine and may enable the automatic braking operation of the ADC to maintain the speed of the vehicle at the driver's setting speed. Thus, the speed of the vehicle may be maintained at the driver's setting speed for auto cruise.

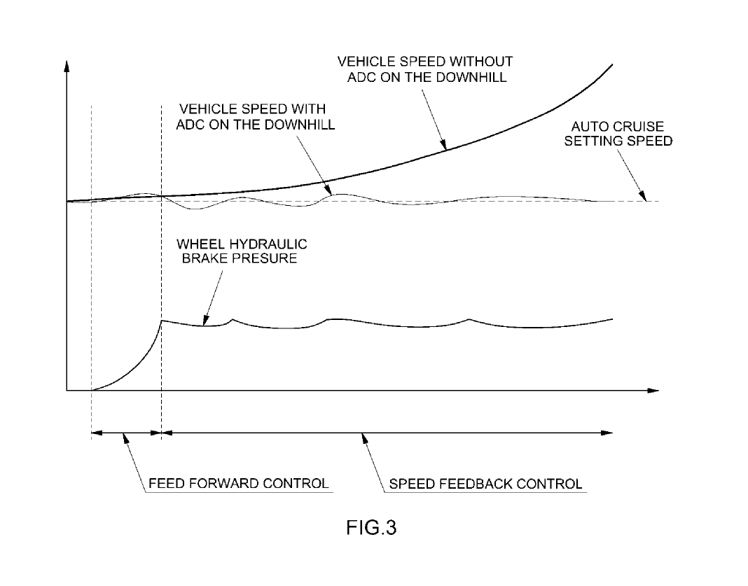

FIG. 3 is an exemplary graph showing a change of the speed of a vehicle according to time and a change of a wheel hydraulic braking pressure by control of an ESC unit. Referring to FIG. 3, when ADC is not applied and the vehicle is operating on the decline, the speed of the vehicle may be increased at an accelerated rate compared to the auto cruise setting speed set by the driver.

On the other hand, when ADC is applied and the vehicle is operating on the decline, the ECU may reduce the quantity of fuel to be supplied to an engine and may enable the automatic braking operation of the ADC to maintain the speed of the vehicle at the driver's setting speed. In addition, while ADC is performed, wheel hydraulic braking pressure may increase due to the distribution of hydraulic pressures by using the ESC unit.

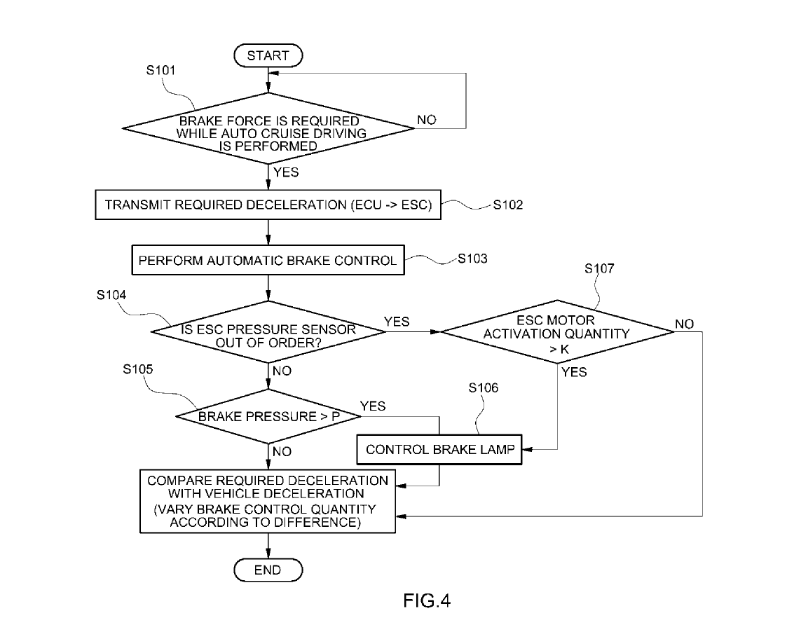

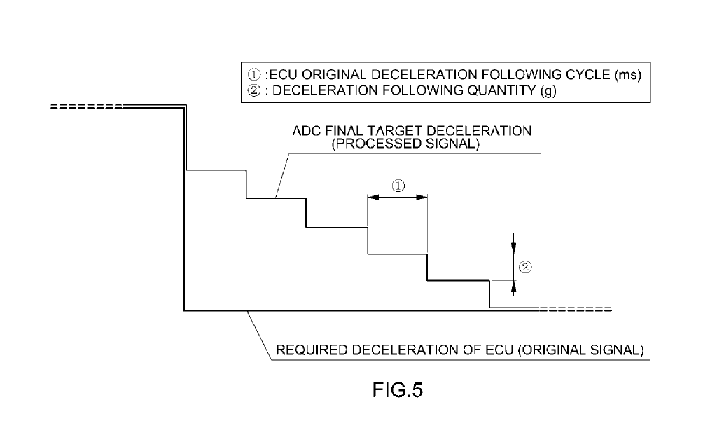

The ADC method for the vehicle according to the present invention will now be described below with reference to FIGS. 4 and 5 in more detail. FIG. 4 is an exemplary flowchart illustrating the ADC method illustrated in FIG. 1, and FIG. 5 is an exemplary waveform diagram illustrating a required signal of an engine control unit (ECU) being processed as a target deceleration signal for smooth deceleration control, by using the ADC method of FIG. 1.

First, a sensor in a vehicle dynamic system may sensor that the vehicle is operating downhill. When a braking force is required as when the vehicle is operating on the decline, while auto cruise driving is enabled (S101), the ECU 14 may transmit a target deceleration of the vehicle to the ESC unit 18 (S102) and the ADC may be performed (S103). In other words, when auto cruise driving is enabled and the speed of the vehicle deviates from an initial setting speed (e.g., speed that is set by the driver), the ECU 14 may adjust an error of the vehicle speed and the quantity of fuel to inject to transmit a required vehicle deceleration value, to the ESC unit 18 via CAN communication, and the ESC unit 18 may perform ADC to output the required vehicle deceleration.

Moreover, to perform ADC, when the ESC unit 18 receives target deceleration of the ECU 14, the ESC unit 18 may calculate deceleration based on a sensing value of a speed sensor disposed on a wheel and may drive a motor included in the ESC unit 18 by pumping and simultaneously, may operate a solenoid valve to be open to distribute a braking solution in a reservoir to the each of one or more hydraulic brakes 22 by pumping driving of the motor.

Thus, the ESC unit 18 may distribute hydraulic pressure suitable for target deceleration of the ECU 14 to the hydraulic brakes 22, and the hydraulic brakes 22 may perform a braking operation up to target deceleration to decrease the speed of the vehicle by target deceleration required by the ECU 14. Furthermore, when the braking force for deceleration is generated, the ECU 14 may calculate appropriate deceleration and may transmit the calculated deceleration to the ESC unit 18 to adjust a hydraulic braking force generated by the ESC unit 18. Moreover, when target deceleration is reached by braking using the hydraulic brakes 22, ADC by the ESC unit 18 may be stopped.

In particular, when the vehicle is operating on the decline and the speed of the vehicle exceeds a predetermined value compared to the driver's auto cruise setting speed, automatic braking activation control by the ESC unit 18, i.e., ADC may be performed by requirement of target deceleration of the ECU 14 to maintain the speed of the vehicle at the auto cruise setting speed when the vehicle is operating on a steep decline.

In addition, when the driver makes a steep downward adjustment of the auto cruise setting speed, the ESC unit 18 may enable the automatic braking operation according to target deceleration of the ECU 14 to decrease the speed of the vehicle may be to the downwardly adjusted auto cruise setting speed.

Referring to FIG. 5, the required deceleration value of the ECU 14 may not be linear and may be transmitted to the ESC unit 18, when ADC is performed using the ESC unit 18, a braking force for initial deceleration may be large compared to a required value, and a sense of difference in driving and a substantially loud braking solution pumping noise of the ESC unit 18 may occur. To solve the problems, a logic for limiting a variation rate of an output target deceleration value of the ECU 14 will be reflected below.

As illustrated in FIG. 5, when a required deceleration signal (e.g., an original signal) of the ECU 14 is transmitted to the ESC unit 18, the ESC unit 18 may calculate a final target deceleration (e.g., a processed signal) for ADC by using two parameters, such as a deceleration following cycle ms (indicated by \textcircled{1} in FIG. 5) of the ECU 14 and a deceleration following quantity g (indicated by \textcircled{2} in FIG. 5) of the ECU 14 to perform a smooth deceleration control.

The ADC described above may be performed when the speed of the vehicle is increased due to gravity and the vehicle is operating on the decline to decrease the speed of the vehicle to the auto cruise setting speed. Since ADC is automatically performed when the driver does not engage the brake pedal, the rear brake lamp 24 may not be turned on, thereby causing potential danger to other drivers.

Thus, while ADC is performed, the ESC may determine whether a pressure sensor mounted in the ESC unit 18 has failed and may measure a braking solution discharge pressure (S104), and when determined that the pressure sensor is operable, the ESC may determine whether a pressure detection value of the pressure sensor exceeds a predetermined reference value P (S105), and when determined that the pressure detection value exceeds the reference value P, the rear brake lamp 24 may be automatically turned on by the ESC unit (S106). Moreover, when determined that the pressure sensor has failed, the rear brake lamp 24 may be turned on by using a motor activation quantity K of the ESC unit 18.

In other words, when the motor activation quantity K (i.e., a motor activation time when the braking solution is pumped) of the ESC unit 18 exceeds the reference value P (S107), an increase in the braking force may be inferred. Thus, the rear brake lamp 24 may be automatically turned on to achieve safe driving by providing a brake warning to the following vehicle.

As described above, the present invention provides the following effects.

According to the present invention, when a vehicle is operating on a steep decline while driving in an auto cruise state and the speed of the vehicle exceeds a predetermined value compared to a driver's auto cruise setting speed, auto cruise downhill control for automatic braking activation may be performed using an electronic stability control (ESC) unit that receives a target deceleration speed of an engine control unit (ECU) to adjust the speed of the vehicle to the driver's auto cruise setting speed when the vehicle is operating on the steep decline.

In addition, when the driver makes a steep downward adjustment of the auto cruise setting speed, similarly, auto cruise downhill control for automatic braking activation may be performed using the ESC unit to decrease the speed of the vehicle to a downwardly adjusted level at an accelerated rate.

Furthermore, when braking activation is performed by auto cruise downhill control according to the present invention, a brake lamp may be automatically turned on/off to ensure safe driving of a rear vehicle.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An auto cruise downhill control (ADC) method for a vehicle, the method comprising:
sensing, by a sensor in a vehicle dynamic system, that the vehicle is operating downhill;
in response to sensing that the vehicle is operating downhill and when a brake force is required while the vehicle is being driven at an auto cruise setting speed, transmitting, by an engine control unit (ECU), a target deceleration value to an electronic stability control (ESC) unit; and
performing, by the ESC unit, ADC to automatically brake the vehicle and to automatically adjust a speed of the vehicle to the auto cruise setting speed,
wherein the ADC comprises:
calculating, by the ESC unit, current deceleration based on a sensing value of a speed sensor disposed on a wheel;
driving a motor included in the ESC unit by pumping and simultaneously operating a solenoid valve to be open to distribute a braking solution in a reservoir to each of one or more hydraulic brakes by pumping driving of the motor;
distributing, by the ESC unit, hydraulic pressures to the one or more hydraulic brakes to achieve a target deceleration; and
performing, by the ESC unit, braking activation to the target deceleration using the hydraulic brakes to adjust the speed of the vehicle to the auto cruise setting speed.

2. (canceled)

3. The ADC method of 1, further comprising:
calculating, by the ESC unit, appropriate deceleration when the braking force is generated to achieve the target deceleration; and
transmitting, by the ESC, the calculated appropriate deceleration to the ESC unit to variably adjust a hydraulic braking force.

4. The ADC method of claim 1, wherein ADC is automatically performed when the vehicle is operating on a steep decline and the current vehicle speed exceeds a predetermined value compared to a driver's auto cruise setting speed and when a driver makes a steep downward adjustment of the auto cruise setting speed.

5. The ADC method of claim 1, further comprising:
calculating, by the ESC unit, a final target deceleration for ADC when a required deceleration signal of the ECU is transmitted to the ESC unit by using parameters including a required deceleration following cycle and a required deceleration following quantity of the ECU.

6. The ADC method of claim 1, further comprising:
automatically turning on, by the ESC unit, a brake lamp when a pressure sensor of the ESC unit is in good order and a pressure detection value of the pressure sensor exceeds a predetermined reference value.

7. The ADC method of claim 1, further comprising:
automatically turning on, by the ESC unit, a brake lamp when the pressure sensor of the ESC unit has failed and a motor activation quantity of the ESC unit exceeds a reference value.

8. A non-transitory computer readable medium containing program instructions executed by a processor or controller, the computer readable medium comprising:
program instructions that sense that the vehicle is operating downhill;
program instructions that transmit a target deceleration value to an electronic stability control (ESC) unit, in response to sensing that the vehicle is operating downhill and when a brake force is required while the vehicle is being driven at an auto cruise setting speed;
program instructions that perform ADC to automatically brake the vehicle and to automatically adjust a speed of the vehicle to the auto cruise setting speed;
program instructions that calculate current deceleration based on a sensing value of a speed sensor disposed on a wheel;
program instructions that drive a motor included in the ESC unit by pumping and simultaneously operating a solenoid valve to be open to distribute a braking solution in a reservoir to each of one or more hydraulic brakes by pumping driving of the motor;
program instructions that distribute hydraulic pressures to the one or more hydraulic brakes to achieve a target deceleration; and
program instructions that perform braking activation to the target deceleration using the hydraulic brakes to adjust the speed of the vehicle to the auto cruise setting speed.

9. (canceled)

10. The non-transitory computer readable medium of claim 8, further comprising:
program instructions that calculate appropriate deceleration when the braking force is generated to achieve the target deceleration; and
program instructions that transmit the calculated appropriate deceleration to the ESC unit to variably adjust a hydraulic braking force.

11. The non-transitory computer readable medium of claim 8, wherein the program instructions are automatically performed when the vehicle is operating on a steep decline and the current vehicle speed exceeds a predetermined value compared to a driver's auto cruise setting speed and when a driver makes a steep downward adjustment of the auto cruise setting speed.

12. The non-transitory computer readable medium of claim 8, further comprising:
program instructions that calculate a final target deceleration for ADC when a required deceleration signal of the ECU is transmitted to the ESC unit by using parameters including a required deceleration following cycle and a required deceleration following quantity of the ECU.

13. The non-transitory computer readable medium of claim 8, further comprising:
program instructions that automatically turn on a brake lamp when a pressure sensor of the ESC unit is in good order and a pressure detection value of the pressure sensor exceeds a predetermined reference value.

14. The non-transitory computer readable medium of claim 8, further comprising:
program instructions that automatically turn on a brake lamp when the pressure sensor of the ESC unit has failed and a motor activation quantity of the ESC unit exceeds a reference value.

15. A auto cruise downhill control system, the system comprising:
a sensor configured to sense that the vehicle is operating downhill;
an engine control unit (ECU) configured to transmit a target deceleration value in response to sensing that the vehicle is operating downhill and when a brake force is required while the vehicle is being driven at an auto cruise setting speed; and
an electronic stability control (ESC) unit configured to receive the transmission from the ECU and perform an auto cruise downhill control to automatically brake the vehicle and to automatically adjust a speed of the vehicle to the auto cruise setting speed,
wherein the ESC unit is configured to calculate current deceleration based on a sensing value of a speed sensor disposed on a wheel, drive a motor included in the ESC unit by pumping and simultaneously operating a solenoid valve to be open to distribute a braking solution in a reservoir to each of one or more hydraulic brakes by pumping driving of the motor, distribute hydraulic pressures to the one or more hydraulic brakes to achieve a target deceleration, and perform braking activation to the target deceleration using the hydraulic brakes to adjust the speed of the vehicle to the auto cruise setting speed.
